(19) United States
(12) Patent Application Publication
(10) Pub. No.: US 2014/0219598 A1
(43) Pub. Date: Aug. 7, 2014

(54) VARIABLE FREQUENCY GENERATOR INPUT SHAFT BEARING

(71) Applicants: Andrew P. Grosskopf, Rockford, IL (US); Liangheng Qiu, Lake in the Hills, IL (US); Glenn C. Lemmers, JR., Loves Park, IL (US)

(72) Inventors: Andrew P. Grosskopf, Rockford, IL (US); Liangheng Qiu, Lake in the Hills, IL (US); Glenn C. Lemmers, JR., Loves Park, IL (US)

(21) Appl. No.: 13/633,494

(22) Filed: Oct. 2, 2012

(51) Int. Cl. F16C 23/08

(52) U.S. Cl. CPC F16C 23/08
USPC 384/495; 29/898.04

(57) ABSTRACT

A ball bearing assembly comprises an inner race configured to support an input shaft extending through a center axis of the ball bearing assembly, and an outer race configured to couple to a bearing support fixture. A bearing cage is disposed between the inner and outer races, the bearing cage having a plurality of apertures spaced apart from one another by a predetermined distance. The ball bearing assembly further includes a plurality of ball elements, each ball element disposed in a respective aperture to define an internal radial clearance that is maintained in response to a misalignment of the input shaft.

### BACKGROUND

The inventive concept generally relates to variable frequency generators (VFGs), and more specifically, to a VFG input shaft bearing.

VFGs are utilized as part of an electrical generating system of an aircraft to output variable frequency power over the engine normal operating speed range. The variable frequency generator typically includes an input shaft that is rotatably connected to an engine accessory gearbox. A shaft bearing is concentrically mounted on the input shaft to facilitate the input shaft rotation.

Recent VFG designs include a detachable drive shaft coupled to one end of the input shaft. This design allows for one end of the input shaft to be disconnected from the drive shaft if a fault in the VFG is detected, while the opposite end of the input shaft remains coupled to the gearbox. Nonetheless, the input shaft continues spinning even after being disconnected from the drive shaft due the rotational drive forced previously applied by the drive shaft. Further, the input shaft may become misaligned relative to the engine gearbox drive shaft due to positional and diametrical size tolerances, thereby placing an undesirable load on the input shaft bearing. Accordingly, the input shaft bearing must maintain proper operation after the input shaft is disconnected to prevent damage to the gearbox.

### BRIEF DESCRIPTION OF THE INVENTIVE CONCEPT

According to at least one exemplary embodiment of the present inventive concept, a generator input shaft assembly comprises a generator housing including a bearing support fixture coupled thereto, and a ball bearing. The ball bearing includes an outer race and an inner race defining a bore having a bore diameter. The outer race is coupled to the bearing support fixture and the inner race is configured to rotate about a center axis. The inner and outer races define a track therebetween that supports a plurality of ball elements. An input shaft extends through the bore along the center axis and includes a first end configured to rotatably couple to a gearbox such that plurality of ball elements maintain an internal radial clearance between the inner and outer races in response to a misalignment of the input shaft occurring in a radial direction with respect to the center axis.

In another exemplary embodiment, a ball bearing assembly comprises an inner race configured to support an input shaft extending through a center axis of the ball bearing assembly, and an outer race configured to couple to a bearing support fixture. A bearing cage is disposed between the inner and outer races, and has a plurality of apertures spaced apart from one another by a predetermined distance. A ball element is disposed in a respective aperture to define an internal radial clearance between the inner and outer races that is maintained in response to a misalignment of the input shaft.

In yet another exemplary embodiment of the present inventive concept, a method of coupling an input shaft to a variable frequency generator comprises coupling an outer race of a ball bearing to a support fixture of the variable frequency generator, and disposing the input shaft having first and second ends through a bore defined by an inner race of the ball bearing such that the input shaft is configured to rotate with respect to the outer race via a plurality of ball elements rolling along a track defined between the outer and inner races. The method further includes coupling the first end to a disconnectable drive shaft of the variable frequency generator and the second end to a gearbox. The plurality of ball elements are configured to maintain an internal radial clearance between the inner and outer races in response to rotating for a predetermine period of time after disconnecting the first end from drive shaft.

### BRIEF DESCRIPTION OF THE DRAWINGS

The subject matter which is regarded as the present inventive concept is particularly pointed out and distinctly claimed in the claims at the conclusion of the specification. The foregoing and other features, and utilities of the present inventive concept are apparent from the following detailed description taken in conjunction with the accompanying drawings in which:

FIG. 1 is a cross-sectional view of variable frequency generator according to an embodiment;

FIG. 2 is an enlarged view of a generator input shaft arrangement included with the variable frequency generator illustrated in FIG. 1;

FIG. 3 is a cross-sectional view illustrating a generator input shaft connected to an aircraft gearbox;

FIG. 4 is a top view of an input shaft bearing assembly according to one embodiment;

FIG. 5 is an isometric view of the input shaft bearing assembly illustrated in FIG. 4;

FIG. 6 is an isometric view of a bearing cage included with the input shaft bearing assembly illustrated in FIG. 5;

FIG. 7 is a side-view of the bearing cage illustrated in FIG. 6; and

FIG. 8 shows ball elements disposed in apertures of the bearing cage illustrated in FIG. 6.

### DETAILED DESCRIPTION

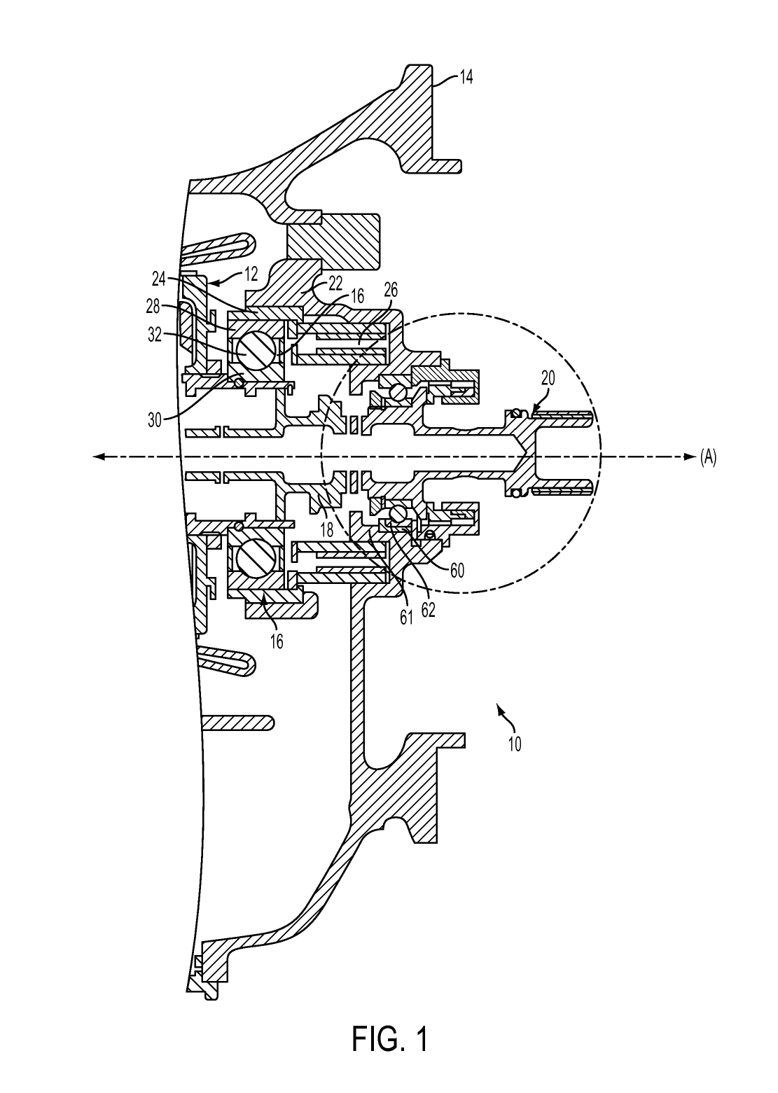

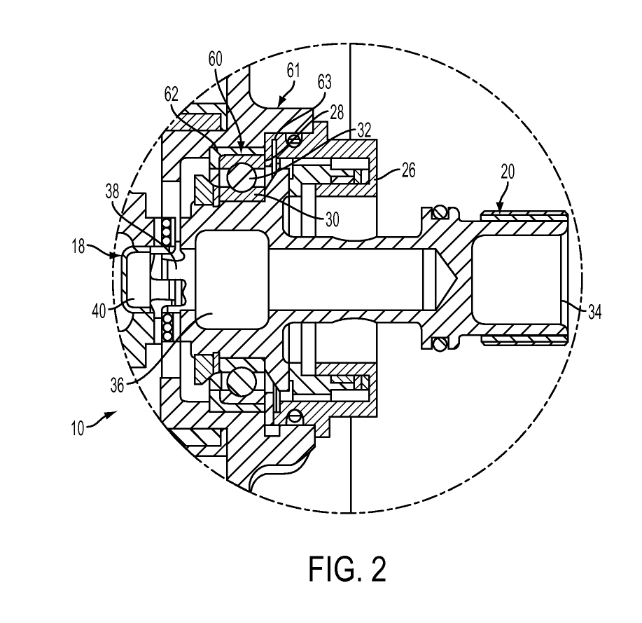

Referring to FIG. 1, a cross-sectional view of variable frequency generator (VFG) 10 is illustrated. The illustrated VFG 10 includes a rotor 12, a stationary housing 14, and a ball bearing assembly 16. The rotor 12 further includes a drive shaft 18 and an input shaft 20 extending along a center axis (A). The housing 14 includes a bearing support structure 22 fixed to a stationary surface thereof. The bearing support structure 22 includes a bearing liner 24, and a biasing mechanism 26. The ball bearing assembly 16 is supported by the bearing support structure 22, which is discussed in greater detail below. The input shaft 20 is supported by a bearing assembly 60. The housing 14 includes a bearing support structure 61 fixed to a stationary surface thereof. The bearing support structure 61 includes a bearing liner 62 and clamping mechanism 63 (shown on FIG. 2).

As illustrated in the enlarged view of the VFG 10 shown in FIG. 2, the ball bearing assembly 60 includes an outer race 28 and an inner race 30. The outer race 28 is coupled to the bearing support structure 61. One or more ball elements 32 are disposed between the outer race 28 and inner race 30, and allow the inner race 30 to rotate about the center axis (A) with respect to the outer race 28. A detailed structure of the ball bearing assembly 60 is discussed in greater detail below.

The bearing liner 62 interconnects with the bearing support structure 61 and clamping mechanism 63, which is disposed axially against an exterior surface of the ball bearing assembly 60. The clamping mechanism 63 may include a bracket mechanism that presses against the ball bearing assembly 60 as illustrated in FIG. 2.

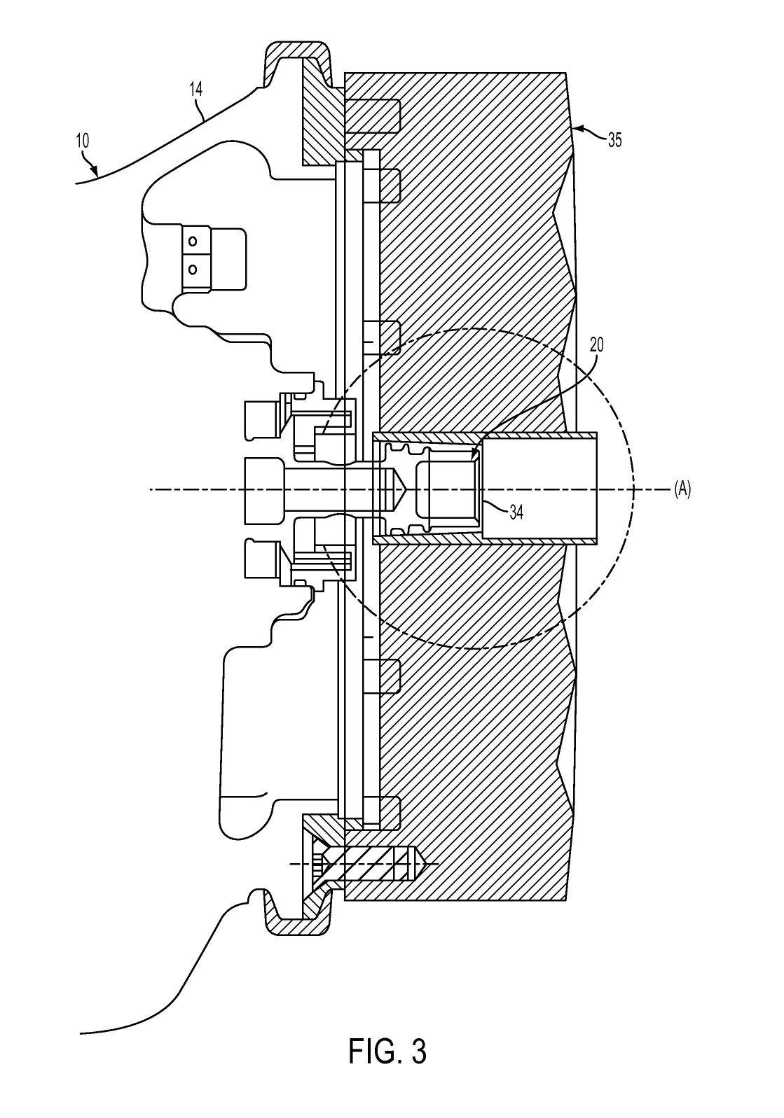

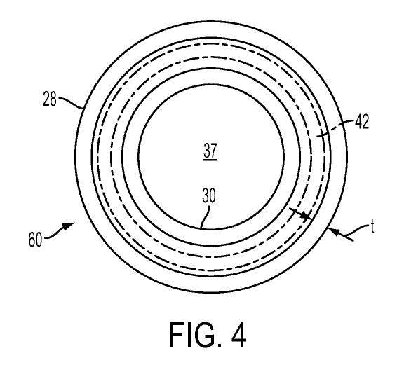

The input shaft 20 extends along the center axis (A) (shown in FIG. 2) and through the bore 37 (shown in FIG. 4) of the ball bearing assembly 60. The input shaft 20 may be fitted against an inner surface of the inner race 30 to be rotationally supported. The illustrated input shaft 20 has a first end 34 and a second end 36. The first end 34 is configured to couple to a gearbox 35, as illustrated in FIG. 3. The gearbox 35 transfers the driving force delivered from the input shaft 20 to a generator that converts mechanical energy to electrical energy.

The second end 36 of the input shaft 20 includes locking portions 38 that extend axially therefrom. The locking portions 38 are configured to selectively couple a clutch device 40 formed at the end of drive shaft 18 opposite the second end 36 of the input shaft 20. If it is detected that the VFG 10 is improperly being driven by the input shaft 20, or other faults are detected such as overheating, etc., the input shaft 20 may be disconnected from the driven shaft 18 via the clutch device 40. Accordingly, the drive force applied by the drive shaft 18 may be removed from the input shaft 20 such that damage to the gearbox 35 may be prevented. Nevertheless, rotational inertia causes the input shaft 20 to substantially rotate for a predetermined period of time after the second end 36 is disconnected from the driven shaft 18. Therefore, the ball bearing assembly 60 should operate properly for a predetermined period of time after the input shaft 20 is disconnected from the drive shaft 18 to prevent damage to the gearbox 35.

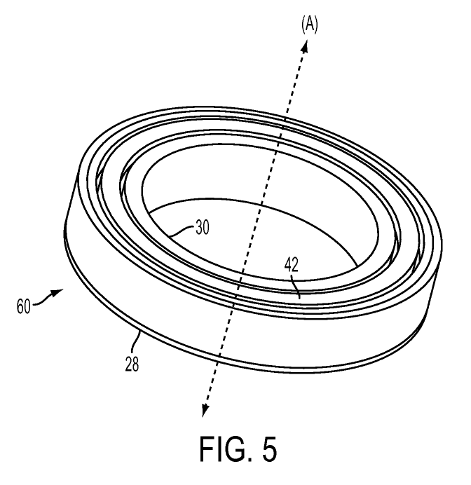

Referring now to FIGS. 4-5, a ball bearing assembly 60 is illustrated according to at least one embodiment. The ball bearing assembly 60 includes the outer race 28 and the inner race 30, as mentioned above. The width of the ball bearing assembly 60 may range from about 0.39 inches (9.91 mm) to about 0.4 inches (10.20 mm). The outer race 28 has a uniform thickness (T) and a diameter ranging from about 2.1 inches (53.35 mm) to about 2.2 inches (55.88 mm). In at least one exemplary embodiment, the outer diameter ranges from about 2.1650 inches (55.00 mm) to about 2.1658 inches (55.01 mm). The inner race 30 defines a bore 37 for receiving an input shaft, as discussed above. The bore 37 may have a bore diameter (d_{B}) ranging from about 1.35 inches (34.29 mm) to about 1.4 inches (35.56 mm). In at least one exemplary embodiment, the d_{B} ranges from about 1.3777 inches (34.9 mm) to about 1.3783 inches (35.0 mm). The outer race 28 may include a split outer race. The races 28, 30 may be formed from a high-temperature resistance, high strength material including, but not limited to, M50 steel and pyrowear 675 steel.

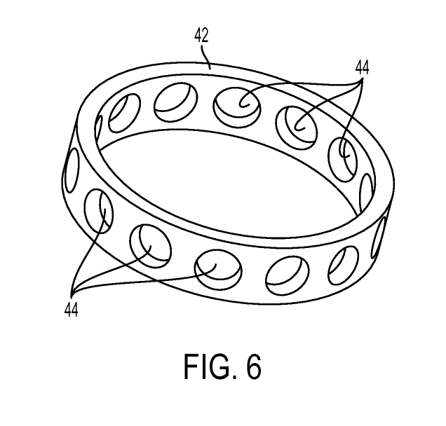

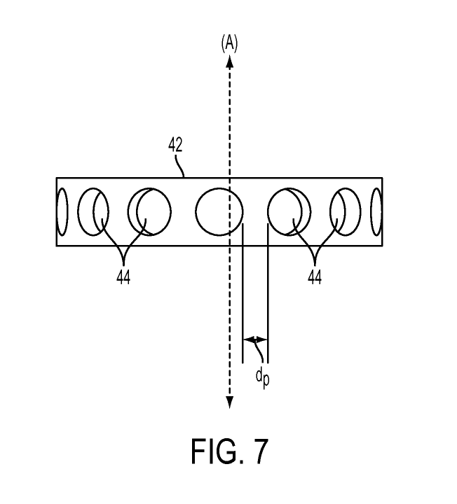

The ball bearing assembly 60 further includes a bearing cage 42 disposed between the outer race 28 and the inner race 30. More specifically, FIGS. 6-7 illustrate a bearing cage 42 according to at least one embodiment. The bearing cage 42 includes a plurality of apertures 44 configured to receive a respective ball element 32, as discussed in greater detail below. The bearing cage 42 may be made from a single piece of metal. In at least one embodiment, the bearing cage 42 may be made out of a single piece of sintered bronze. The sintered bronze bearing cage may also be formed as an outer land riding cage having a porous surface that absorbs and/or traps oil. Alternatively, the bearing cage 42 may be made from a single piece of steel. The steel bearing cage 42 may be formed as an inner land riding cage that expands when the rotational speed of the ball bearing assembly 60 exceeds a predetermined speed, such as 22,000 rpm. Accordingly, the ball bearing assembly 60 may withstand low lubrication conditions, while still operating sufficiently for a prolonged period of time, such as a time period ranging from about 40 hours to about 55 hours.

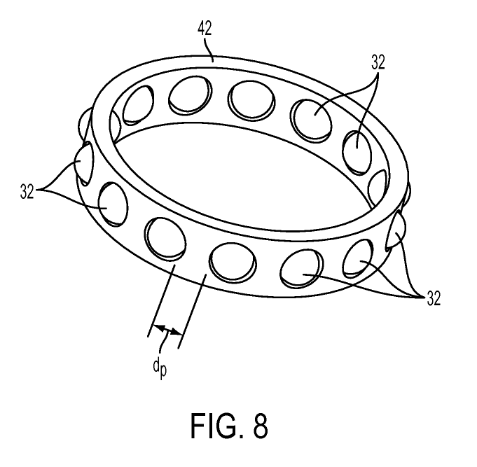

Referring to FIG. 8, the ball bearing cage 42 is illustrated with ball elements 32 disposed in a respective aperture 44. The ball elements 32 may be formed from silicon nitride. Further, the ball elements 32 according to at least one exemplary embodiment have a ball diameter of about 0.250 inches (6.35 mm) and a grade of 10.

In at least one exemplary embodiment of the present general inventive concept, the ball bearing cage 42 comprises fourteen apertures 44 configured to rotationally support fourteen ball elements 32. Accordingly, the pitch distance (d_{P}) between each aperture 44 may be increased, thereby forming a thicker cross member between each ball element 32 to accommodate high speeds, such 22,000 rpm or greater. For example, the pitch distance d_{P} may range from about 0.25 inches (6.35 mm) to about 0.3 inches (7.62 mm).

The size and arrangement of the ball elements 32 define an internal radial clearance between the plurality of ball elements 32 and the racers 28, 30. The internal radial clearance allows for thermal expansion and misalignment of the inner and outer races as the ball bearing assembly 60 reaches high rotational speeds, such as 22,000 rpm to reduce the chance the ball bearing assembly 60 binds and fails. In at least one exemplary embodiment, the internal radial clearance of the ball bearing assembly 60 ranges from about 0.0030 inches (0.0762 mm) to 0.0037 inches (0.0940 mm). Accordingly, the ball bearing assembly 60 is configured to maintain proper operation when the input shaft 20 becomes misaligned with respect to the center axis (A). For example, the ball bearing assembly 60 may maintain proper operation when an input shaft misalignment occurs ranging from about 0.25 degrees to about 0.32 degrees. That is, the ball bearing assembly 60 may avoid binding during a substantial misalignment of the input shaft 20.

While the present inventive concept has been described in detail in connection with only a limited number of exemplary embodiments, it should be readily understood that the present inventive concept is not limited to such disclosed exemplary embodiments. Rather, the present inventive concept can be modified to incorporate any number of variations, alterations, substitutions or equivalent arrangements not heretofore described, but which are commensurate with the spirit and scope of the present inventive concept. Additionally, while various exemplary embodiments of the present inventive concept have been described, it is to be understood that features of the present inventive concept may include only some of the described exemplary embodiments. Accordingly, the present inventive concept is not to be seen as limited by the foregoing description, but is only limited by the scope of the appended claims.

1. A generator input shaft assembly, comprising:
a generator housing including a bearing support fixture coupled thereto;
a ball bearing including an outer race and an inner race defining a bore having a bore diameter, the outer race coupled to the bearing support structure the inner race configured to rotate about a center axis, the inner and outer races defining a track therebetween that supports a plurality of ball elements;
an input shaft extending through the bore along the center axis and including a first end configured to rotatably couple to a gearbox; and
a bearing cage within the ball bearing for supporting the plurality of ball elements such that they maintain an internal radial clearance between the inner and outer races in response to a misalignment of the input shaft in a radial direction with respect to the center axis.

2. The generator input shaft assembly, of claim 1, wherein the misalignment ranges from 0.25 degrees to 0.32 degrees.

3. The generator input shaft assembly of claim 2, wherein the internal radial clearance ranges from 0.0030 inches (0.0762 mm) to 0.0037 inches (0.0940 mm).

4. The generator input shaft assembly of claim 3, wherein the ball bearing further comprises a bearing cage disposed between the inner and outer races, the bearing cage having a plurality of apertures spaced apart from one another by a predetermined distance.

5. The generator input shaft assembly of claim 4, wherein the plurality of apertures comprises fourteen apertures and the number of ball elements comprises fourteen ball elements.

6. The generator input shaft assembly of claim 5, wherein the outer race is a split outer race.

7. The generator input shaft assembly of claim 6, wherein the bearing cage is formed of a single piece.

8. The generator input shaft assembly of claim 7, wherein the bearing cage is formed from sintered bronze and is outer land riding.

9. The generator input shaft assembly of claim 8, wherein the sintered bronze bearing cage has a porous surface configured to absorb oil released into the generator housing.

10. The generator input shaft assembly of claim 7, wherein the bearing cage is an inner land riding steel bearing cage formed from steel and is configured to expand in response to the input shaft rotating in excess of a predetermined speed.

11. A ball bearing assembly, comprising:
an inner race configured to support an input shaft extending through a center axis of the ball bearing assembly;
an outer race configured to couple to a bearing support fixture;
a bearing cage disposed between the inner and outer races, the bearing cage having a plurality of apertures spaced apart from one another by a predetermined distance; and
a plurality of ball elements, each ball element disposed in a respective aperture to define an internal radial clearance that is maintained in response to a misalignment of the input shaft.

12. The ball bearing assembly of claim 11, wherein the ball bearing assembly has a bore diameter ranging from 1.35 inches to 1.4 inches such that the inner race is configured to support an input shaft of a variable frequency generator.

13. The ball bearing assembly of claim 12, wherein the internal radial clearance ranges from 0.0030 inches (0.0762 mm) to 0.0037 inches (0.0940 mm).

14. The ball bearing assembly of claim 11, wherein the misalignment ranges from 0.25 degrees to 0.32 degrees in a radial direction with respect to the center axis.

15. The ball bearing assembly of claim 11, wherein the plurality of apertures comprises fourteen apertures and the number of ball elements comprises fourteen ball elements.

16. The ball bearing assembly of claim 11, wherein the outer race is a split outer race and the bearing cage is formed of a single piece.

17. The ball bearing assembly of claim 16 wherein the bearing cage is sintered bronze bearing cage having a porous surface configured to absorb oil.

18. The ball bearing assembly of claim 16, wherein the bearing cage is a steel bearing cage formed of steel and includes an inner land riding cage configured to expand in response to the input shaft rotating in excess of a predetermined speed.

19. The ball bearing assembly of claim 18, wherein the inner and outer races are formed from high-temperature resistant steel comprising at least one of pyrowear 675 steel and M50 steel.

20. A method of coupling an input shaft to a variable frequency generator, comprising:
coupling an outer race of a ball bearing to a support fixture of the variable frequency generator;
disposing the input shaft having first and second ends through a bore defined by an inner race of the ball bearing such that the input shaft is configured to rotate with respect to the outer race via a plurality of ball elements rolling along a track defined between the outer and inner races; and
coupling the first end to a disconnectable drive shaft of the variable frequency generator and the second end to a gearbox, the plurality of ball elements rotationally supported by a bearing cage for maintaining an internal radial clearance between the inner and outer races in response to the input shaft rotating for a predetermine period of time after disconnecting the first end from drive shaft.
